(19) United States
(12) Patent Application Publication
(10) Pub. No.: US 2022/0294015 A1
(43) Pub. Date: Sep. 15, 2022

(54) NONAQUEOUS ELECTROLYTE SECONDARY BATTERY

(71) Applicant: Prime Planet Energy & Solutions, Inc., Tokyo (JP)

(72) Inventors: Kento HOSOE, Miyoshi-shi (JP); Shinsuke MATSUHARA, Miyoshi-shi (JP)

(21) Appl. No.: 17/692,199

(22) Filed: Mar. 11, 2022

(30) Foreign Application Priority Data
Mar. 15, 2021 (JP) 2021-041687

(51) Int. Cl. H01M 10/0567; H01M 4/62; H01M 10/0587; H01M 10/0525

(52) U.S. Cl. CPC H01M 10/0567; H01M 4/62; H01M 10/0587; H01M 10/0525; H01M 2004/027

(57) ABSTRACT

Provided is a nonaqueous electrolyte secondary battery in which a nonaqueous electrolyte solution contains lithium bis(oxalato)borate, and in which initial resistance is reduced and resistance to metallic Li precipitation is high. The nonaqueous electrolyte secondary battery disclosed herein includes an electrode body having a positive electrode, a negative electrode, and a separator; and a nonaqueous electrolyte solution. The negative electrode has a negative electrode active material layer. The nonaqueous electrolyte solution contains lithium bis(oxalato)borate. The Na content in the negative electrode active material layer, determined by laser ablation ICP mass spectrometry, is 311 μg/g or lower.

### BACKGROUND OF THE INVENTION

### 1. Field of the Invention

The present disclosure relates to a nonaqueous electrolyte secondary battery. The present application claims priority to Japanese Patent Application No. 2021-041687 filed on Mar. 15, 2021, the entire contents of which are incorporated in the present specification by reference.

### 2. Description of the Related Art

In recent years, nonaqueous electrolyte secondary batteries such as lithium ion secondary batteries are suitably used as portable power sources in personal computers, mobile terminals and the like, and also as power sources for vehicle drive in, for instance, battery electric vehicles (BEV), hybrid electric vehicles (HEV) and plug-in hybrid electric vehicles (PHEV).

One known technique herein involves adding lithium bis(oxalato)borate (LiBOB) to a nonaqueous electrolyte solution of a nonaqueous electrolyte secondary battery. Through addition of LiBOB, a favorable coating film can be formed on the negative electrode, and leaching of transition metals from the positive electrode active material can be prevented, whereby increases in resistance can be suppressed as a result. On the other hand, Na becomes mixed as an impurity into the nonaqueous electrolyte secondary battery. This contaminating Na may react with LiBOB, to produce sodium bis(oxalato)borate (NaBOB).

A known technique aimed at reducing the amount of NaBOB generated within the nonaqueous electrolyte secondary battery involves washing the electrodes with an electrolyte solution containing LiBOB. For instance, Japanese Patent Application Publication No. 2018-26297 discloses a technique in which a stacked-type electrode body is produced using electrodes that contain Na as an impurity, a first end of a stacked-type electrode group in a direction perpendicular to the stacking direction is immersed in an electrolyte solution that contains LiBOB, to let the electrolyte solution permeate towards a second end opposite the first end, followed by removal of a region of the stacked-type electrode body that includes the second end. In this technique, Na contained in the electrodes reacts with LiBOB when the electrolyte solution permeates into the electrode body, and the generated NaBOB migrates towards the second end of the electrode body accompanying the permeation of the electrolyte solution. Thereupon, NaBOB can be removed to certain extent by removing a region that includes the second end.

### SUMMARY OF THE INVENTION

As a result of diligent research, the inventors have found, however, that the above conventional technique has room for improvement in terms of reducing initial resistance and increasing resistance to metallic Li precipitation.

Such being the case, it is an object of the present disclosure to provide a nonaqueous electrolyte secondary battery in which a nonaqueous electrolyte solution contains lithium bis(oxalato)borate, and in which initial resistance is reduced, and resistance to metallic Li precipitation is high.

The inventors diligently studied amounts of Na in various battery constituent members. As a result, the inventors have found that the amount of Na can be significantly reduced through improvements in a thickener and a binder that are used in the negative electrode. Further studies by the inventors have revealed that Na contained in the negative electrode, from among Na contained in the constituent members of the battery, exerts a significant adverse effect on battery characteristics.

Therefore, the nonaqueous electrolyte secondary battery disclosed herein includes an electrode body having a positive electrode, a negative electrode, and a separator; and a nonaqueous electrolyte solution. The negative electrode has a negative electrode active material layer. The nonaqueous electrolyte solution contains lithium bis(oxalato)borate. The Na content in the negative electrode active material layer, determined by laser ablation ICP mass spectrometry, is 311 μg/g or lower.

Thanks to such a configuration, a nonaqueous electrolyte secondary battery is provided in which a nonaqueous electrolyte solution contains lithium bis(oxalato)borate, and in which initial resistance is reduced, and resistance to metallic Li precipitation is high.

In a desired implementation of the nonaqueous electrolyte secondary battery disclosed herein, the positive electrode has a positive electrode active material layer. A ratio (%) of the Na content in the negative electrode active material layer relative to the total of Na content in the positive electrode active material layer, Na content in the negative electrode active material layer, and Na content in the separator, is 33% or lower. By virtue of such a configuration, the initial resistance becomes lower and the resistance to metallic Li precipitation becomes higher.

In a desired implementation of the nonaqueous electrolyte secondary battery disclosed herein, a ratio (%) of a resistance value at a site of highest resistance relative to a resistance value at a site of lowest resistance, upon measurement of a resistance distribution along a short-side direction of a main surface of the negative electrode active material layer, is 1.10 or lower. By virtue of such a configuration, the initial resistance becomes lower and the resistance to metallic Li precipitation becomes higher.

In a desired implementation of the nonaqueous electrolyte secondary battery disclosed herein, the negative electrode active material layer contains a negative electrode active material, a binder and a thickener. The thickener is a salt of carboxymethyl cellulose, and at least part of cations of the carboxymethyl cellulose salt are Li ions. By virtue of such a configuration, the initial resistance becomes lower and the resistance to metallic Li precipitation becomes higher.

In a desired implementation of the nonaqueous electrolyte secondary battery disclosed herein, the negative electrode active material layer contains a negative electrode active material, and a Na-free acrylic binder. By virtue of such a configuration, the initial resistance becomes lower and the resistance to metallic Li precipitation becomes higher.

In a desired implementation of the nonaqueous electrolyte secondary battery disclosed herein, the electrode body is a wound electrode body. Such a configuration elicits a yet more pronounced effect of lowering initial resistance.

### BRIEF DESCRIPTION OF THE DRAWINGS

FIG. 1 is a cross-sectional diagram illustrating schematically the internal structure of a lithium ion secondary battery according to an embodiment of the present disclosure; and

FIG. 2 is a schematic exploded-view diagram illustrating the configuration of a wound electrode body in a lithium ion secondary battery according to an embodiment of the present disclosure.

### DESCRIPTION OF THE PREFERRED EMBODIMENTS

Desired embodiments of the present disclosure will be explained below with reference to accompanying drawings. Any features other than the matter specifically set forth in the present specification and that may be necessary for carrying out the present disclosure can be regarded as design matter for a person skilled in the art based on conventional art in the relevant field. The present disclosure can be realized on the basis of the disclosure of the present specification and common technical knowledge in the relevant field. In the drawings below, members and portions that elicit identical effects are denoted with identical reference symbols. The dimensional relationships (length, width, thickness and so forth) in the drawings do not reflect actual dimensional relationships.

In the present specification, the term “secondary battery” denotes a power storage device in general capable of being charged and discharged repeatedly, and includes so-called storage batteries and power storage elements such as electrical double layer capacitors. In the present specification, the term “lithium ion secondary battery” denotes a secondary battery that utilizes lithium ions as charge carriers, and in which charging and discharge are realized as a result of movement of charge with lithium ions, between the positive electrode and the negative electrode.

A flat square lithium ion secondary battery provided with a wound electrode body will be explained hereafter in detail as an example, but the present disclosure is not meant to be limited to such an embodiment.

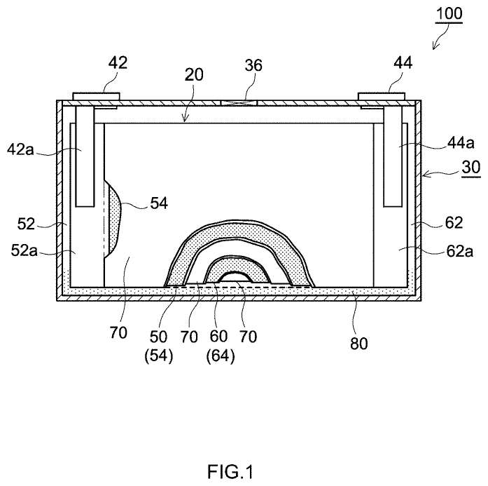

A lithium ion secondary battery 100 illustrated in FIG. 1 is a sealed battery constructed by accommodating a flat-shaped wound electrode body 20 and a nonaqueous electrolyte solution 80 in a flat square battery case (i.e. outer container) 30. The battery case 30 is provided with a positive electrode terminal 42 and a negative electrode terminal 44 for external connection, and a thin-walled safety valve 36 set to release the internal pressure in the battery case 30 when the internal pressure rises to or above a predetermined level. An injection port (not shown) for injecting the nonaqueous electrolyte solution 80 is provided in the battery case 30. The positive electrode terminal 42 is electrically connected to a positive electrode collector plate 42a. The negative electrode terminal 44 is electrically connected to a negative electrode collector plate 44a. For instance, a lightweight metallic material of good thermal conductivity, such as aluminum, is used as the material of the battery case 30.

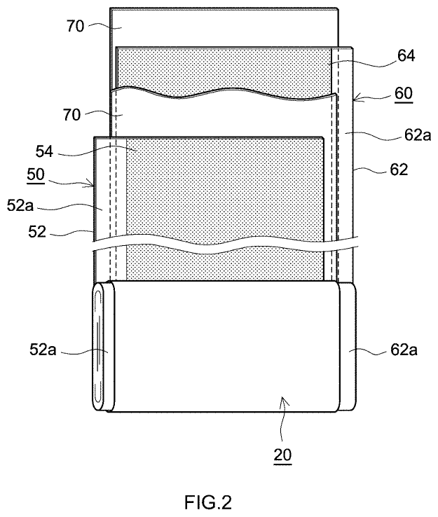

As illustrated in FIG. 1 and FIG. 2, the wound electrode body 20 has a configuration resulting from laminating a positive electrode sheet 50 and a negative electrode sheet 60 with two elongated separator sheets 70 interposed in between, and then winding the resulting laminate in the longitudinal direction. The positive electrode sheet 50 has a configuration in which a positive electrode active material layer 54 is formed, along the longitudinal direction, on one or both faces (herein both faces) of an elongated positive electrode collector 52. The negative electrode sheet 60 has a configuration in which a negative electrode active material layer 64 is formed, along the longitudinal direction, on one or both faces (herein both faces) of an elongated negative electrode collector 62. A positive electrode active material layer non-formation section 52a (i.e. exposed portion of the positive electrode collector 52 at which the positive electrode active material layer 54 is not formed) and a negative electrode active material layer non-formation section 62a (i.e. exposed portion of the negative electrode collector 62 at which the negative electrode active material layer 64 is not formed) are formed so as to respectively protrude outward from either edge of the wound electrode body 20 in a winding axis direction thereof (i.e. sheet width direction perpendicular to the longitudinal direction). The positive electrode active material layer non-formation section 52a and the negative electrode active material layer non-formation section 62a are joined to the positive electrode collector plate 42a and the negative electrode collector plate 44a, respectively.

Examples of the positive electrode collector 52 that makes up the positive electrode sheet 50 include an aluminum foil. Examples of the positive electrode active material contained in the positive electrode active material layer 54 include lithium-transition metal oxides (for example LiNi_{1/3}Co_{1/3}Mn_{1/3}O₂, LiNiO₂, LiCoO₂, LiFeO₂, LiMn₂O₄ and LiNi_{0.5}Mn_{1.5}O₄), and lithium-transition metal phosphate compounds (for example LiFePO₄).

The positive electrode active material layer 54 may contain components other than the active material, for instance, a conductive material and a binder. For instance, carbon black such as acetylene black (AB) or some other carbon material (for example, graphite) can be suitably used as the conductive material. For instance, polyvinylidene fluoride (PVDF) can be used as the binder.

Each separator 70 is a porous member, and a porous sheet (film) made of a resin such as polyethylene (PE), polypropylene (PP), polyester, cellulose or polyamide is suitably used as the separator. Such a porous sheet may have a single-layer structure or a multilayer structure of two or more layers (for instance, a three-layer structure in which PP layers are laid on both faces of a PE layer).

A heat resistant layer (HRL) may be provided on the surface of the separator 70. The HRL may be the same as or similar to heat-resistant layers of separators in known nonaqueous electrolyte secondary batteries. For instance, the separator 70 contains ceramic particles of alumina, silica, boehmite, magnesia, titania or the like, and a binder such as PVDF.

Examples of the negative electrode collector 62 that makes up the negative electrode sheet 60 include a copper foil. For instance, a carbon material such as graphite, hard carbon or soft carbon can be used as the negative electrode active material contained in the negative electrode active material layer 64. The negative electrode active material layer 64 may contain components other than the active material, for instance, a binder and a thickener.

In the interior of the lithium ion secondary battery 100, there may be present Na, for instance, derived from impurities of the positive electrode active material, impurities of the binder of the positive electrode active material layer 54, impurities in the HRL of the separator 70, and impurities of the binder and the thickener of the negative electrode active material layer 64. Such Na reacts with LiBOB, to generate NaBOB that adversely impacts battery characteristics such as initial resistance. Assiduous studies by the inventors have revealed, as made apparent in the results of the examples and comparative examples described later, that Na contained in the negative electrode exerts a large adverse effect on battery characteristics, among Na contained in the constituent members of the battery. In the present embodiment, therefore, the content of Na in the negative electrode active material layer 64, as determined by laser ablation ICP mass spectrometry, is 311 μg/g or lower. Within such a Na content range, the initial resistance drops conspicuously, and resistance to metallic Li precipitation improves remarkably. From the viewpoint of achieving a yet lower initial resistance and yet higher resistance to metallic Li precipitation, the Na content in the negative electrode active material layer 64 is desirably 200 μg/g or lower, more desirably 100 μg/g or lower, yet more desirably 50 μg/g or lower, and most desirably 10 μg/g or lower.

The Na content in the positive electrode active material layer 54, determined by laser ablation ICP mass spectrometry, is not particularly limited, and may be 100 μg/g or higher, or 150 μg/g or higher, or 180 μg/g or higher, and may be 300 μg/g or lower, or 250 μg/g or lower. The Na content in the separators 70, determined by laser ablation ICP mass spectrometry, is not particularly limited, and may be 100 μg/g or higher, or 150 μg/g or higher, or 200 μg/g or higher, and may be 300 μg/g or lower, or 250 μg/g or lower.

It should be noted that the laser ablation ICP mass spectrometry can be performed using a known laser ICP mass spectrometry (LA-ICP-MS) device.

The composition of the negative electrode active material layer 64 is not particularly limited, so long as the Na content is 311 μg/g or lower.

One exemplary method for reducing the Na content in the negative electrode active material layer 64 involves reducing the Na content, as an impurity, in the binder. The most commonplace binder used in negative electrode active material layers is styrene-butadiene rubber (SBR). However, SBR contains an impurity in the form of NaOH that used in the synthesis of SBR. Therefore, the Na content in the negative electrode active material layer 64 can be reduced by using, as the binder, a binder synthesized without using a Na-containing component. Specifically, the Na content in the negative electrode active material layer 64 can be reduced by using, as the binder, styrene-butadiene rubber synthesized by using LiOH instead of NaOH.

In addition, studies by the inventors have revealed that the amount of Na can be significantly reduced through improvements in the thickener that is used in the negative electrode. Specifically, the most commonplace thickener used in negative electrode active material layers is carboxymethyl cellulose (CMC), and in the synthesis thereof, NaOH is utilized. As a result, some carboxyl groups form a salt with Na ions. Therefore, general CMC used for negative electrodes contains Na. That is, CMC used as a thickener in a negative electrode active material layer can be deemed to actually be a Na salt of CMC. The Na content of the negative electrode active material layer 64 can therefore be reduced by using, as the thickener, a thickener synthesized without utilizing a Na-containing component. Specifically, the Na content of the negative electrode active material layer 64 can be reduced by utilizing CMC synthesized using LiOH as a thickener. The CMC synthesized using LiOH can be regarded as a CMC salt such that some cations thereof include at least Li; a desired thickener is thus a lithium salt of CMC. In the lithium salt of CMC, desirably from 80 mol % to 90 mol % of the carboxyl groups form a salt with Li.

Moreover, the Na content of the negative electrode active material layer 64 can be reduced by using a binder that functions both as a thickener and a binder, and that is synthesized without using a Na-containing component. A binder synthesized without using a Na-containing component can be regarded as a binder that contains no Na. Examples of such a binder include acrylic binders synthesized without using a Na-containing component (i.e. an acrylic binder containing no Na). In one desired implementation of the negative electrode active material layer 64, therefore, the negative electrode active material layer 64 contains a negative electrode active material, and a Na-free acrylic binder, and in a yet more desirable implementation, the negative electrode active material layer 64 contains only a negative electrode active material and a Na-free acrylic binder.

The content of the negative electrode active material in the negative electrode active material layer 64 is not particularly limited, but is desirably 70 mass % or higher, more desirably 80 mass % or higher, and yet more desirably 90 mass % or higher. The content of the binder in the negative electrode active material layer 64 is not particularly limited, but is desirably from 0.1 mass % to 8 mass %, more desirably from 0.2 mass % to 3 mass %, and yet more desirably from 0.3 mass % to 2 mass %. The content of the thickener in the negative electrode active material layer 64 is not particularly limited, but is desirably from 0.3 mass % to 3 mass %, and more desirably from 0.4 mass % to 2 mass %.

From the viewpoint of achieving a yet lower initial resistance and yet higher resistance to metallic Li precipitation, the ratio (%) of the Na content in the negative electrode active material layer 64 relative to the total of the Na content in the positive electrode active material layer 54, the Na content in the negative electrode active material layer 64, and the Na content in the separators 70, is, for instance, 45% or lower, desirably 33% or lower, more desirably 10% or lower, yet more desirably 5% or lower, and most desirably 3% or lower.

From the viewpoint of achieving a yet lower initial resistance and yet higher resistance to metallic Li precipitation, the ratio (%) of a resistance value at a site of highest resistance relative to a resistance value at a site of lowest resistance, upon measurement of a resistance distribution along a short-side direction (i.e. width direction) of a main surface of the negative electrode active material layer 64, is, for instance, 1.17 or lower, desirably 1.10 or lower, or less more desirably 1.07 or lower, and yet more desirably 1.05 or lower. The site of highest resistance in the wound electrode body 20 is ordinarily the central portion in the winding axis direction (specifically, a region up to ±20% from the center, in particular a region up to ±10% from the center).

The resistance distribution can be measured by measuring resistance values at predetermined intervals (for instance, at 5 mm-intervals over 30% of the negative electrode active material layer 64 from the end portions thereof, relative to the total width of the negative electrode active material layer 64, and at 2 mm-intervals at the central portion (the remaining 40% portion)), in accordance with the AC impedance method, along the short-side direction of a main surface of the negative electrode active material layer 64.

The nonaqueous electrolyte solution 80 contains lithium bis(oxalato)borate (LiBOB). Further, the nonaqueous electrolyte solution 80 typically contains a nonaqueous solvent and a supporting salt. For instance, various organic solvents such as carbonates, ethers, esters, nitriles, sulfones, and lactones that are utilized in electrolyte solutions of lithium ion secondary batteries in general can be used without particular limitations, as the nonaqueous solvent. Desired among the foregoing are carbonates, and concrete examples thereof include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyldifluoromethyl carbonate (F-DMC) and trifluorodimethyl carbonate (TFDMC). Such nonaqueous solvents can be used singly or in combinations of two or more types, as appropriate.

For instance, a lithium salt such as LiPF₆, LiBF₄ or LiClO₄ (desirably LiPF₆) can be used as the electrolyte salt. The concentration of the supporting salt is desirably from 0.7 mol/L to 1.3 mol/L.

The content of LiBOB in the nonaqueous electrolyte solution 80 is, for instance, 0.1 mass % or higher, desirably 0.3 mass % or higher, and more desirably 0.5 mass % or higher. On the other hand, the content of LiBOB in the nonaqueous electrolyte solution 80 is, for instance, 1.5 mass % or lower, desirably 1.0 mass % or lower, and more desirably 0.7 mass % or lower.

So long as the effect of the present disclosure is not significantly impaired thereby, the above nonaqueous electrolyte solution 80 may contain various additives, for instance, a gas generating agent such as biphenyl (BP) or cyclohexylbenzene (CHB); a coating film forming agent such as vinylene carbonate (VC); a dispersant; and a thickener.

The lithium ion secondary battery 100 thus configured can be used in various applications. Suitable examples of applications include drive power sources mounted on vehicles such as battery electric vehicles (BEV), hybrid electric vehicles (HEV), and plug-in hybrid electric vehicles (PHEV). The lithium ion secondary battery 100 may also be used in the form of a battery pack typically resulting from connection of a plurality of the lithium ion secondary batteries 100 in series and/or in parallel.

A square lithium ion secondary battery 100 having a wound electrode body 20 has been explained above as an example. The electrode body 20 of the lithium ion secondary battery 100 may be a stacked-type electrode body in which a plurality of positive electrodes and a plurality of negative electrodes are alternately laid up on each other with a separator interposed therebetween. In the wound electrode body 20, however, the nonaqueous electrolyte solution 80 permeates into the wound electrode body 20 from both open ends thereof at the time of impregnation of the wound electrode body 20 with the nonaqueous electrolyte solution 80, in the production process of the lithium ion secondary battery 100. As a result, NaBOB accumulates readily at the central portion of the wound electrode body 20 in the winding axis direction. The wound electrode body 20 is therefore more susceptible to adverse effects derived from NaBOB than a stacked-type electrode body. In the wound electrode body 20, specifically, resistance increases readily in the central portion. The initial resistance lowering effect is thus remarkable in a case where the electrode body 20 of the lithium ion secondary battery 100 is a wound electrode body. Moreover, NaBOB is difficult to be removed by the technique disclosed in Japanese Patent Application Publication No. 2018-26297 in a case where the electrode body 20 of the lithium ion secondary battery 100 is a wound electrode body.

The configuration of the lithium ion secondary battery 100 is not limited to the above configuration, and the lithium ion secondary battery 100 can be configured in the form of a cylindrical lithium ion secondary battery, a laminate-cased lithium ion secondary battery or the like. The art disclosed herein can also be applied to a nonaqueous electrolyte secondary battery other than a lithium ion secondary battery.

Examples pertaining to the present disclosure will be explained below, but the present disclosure is not meant to be limited to the features illustrated in the examples.

Preparation of a Negative Electrode

Styrene-butadiene rubber (SBR) synthesized using NaOH as a neutralizing agent was prepared as a binder A. Moreover, styrene-butadiene rubber synthesized by using LiOH as a neutralizing agent was prepared as a binder B with the low Na content.

Carboxymethyl cellulose (sodium salt) synthesized using NaOH was prepared as a thickener A. Moreover, carboxymethyl cellulose synthesized using LiOH (lithium salt of carboxymethyl cellulose in which 88 mol % of the carboxyl groups formed salts with Li) was prepared as a thickener B with the low Na content.

Further, an acrylic binder synthesized without using a Na-containing component was prepared as a binder having functions of both a binder and a thickener.

Natural graphite (C) as a negative electrode active material, a binder, and a thickener were mixed with ion-exchanged water at a mass ratio of C:binder:thickener=98:1:1, to prepare a slurry for forming a negative electrode active material layer. This slurry was applied onto both faces of an elongated copper foil, was dried, and was thereafter pressed, to produce a negative electrode sheet. In a case where the above acrylic binder was used, natural graphite (C) and the acrylic binder were used at a mass ratio of C:acrylic binder=98:2.

Four types of negative electrode sheets A to D were produced in terms of binder and thickener, namely a combination of binder A and thickener A, a combination of binder B and thickener A, a combination of binder A and thickener B, and an acrylic binder alone.

Part of the negative electrode active material layer of the obtained negative electrode sheet was cut out. Laser ablation ICP mass spectrometry was performed on this cutout as a sample, using a laser ICP mass spectrometer, to measure the Na content in the negative electrode active material layer. The results showed that the Na content in the negative electrode active material layer in the negative electrode sheet A was 420 μg/g, the Na content in the negative electrode active material layer in the negative electrode sheet B was 311 μg/g, the Na content in the negative electrode active material layer in the negative electrode sheet C was 191 μg/g, and the Na content in the negative electrode active material layer in the negative electrode sheet D was 9 μg/g.

Preparation of a Positive Electrode

Herein LiNi_{1/3}Co_{1/3}Mn_{1/3}O₂ (LNCM) as a positive electrode active material, acetylene black (AB) as a conductive material and polyvinylidene fluoride (PVdF) as a binder were mixed, at a mass ratio of LNCM:AB:PVdF=90:8:2, with N-methylpyrrolidone (NMP), to prepare a slurry for forming a positive electrode active material layer. This slurry was applied onto both faces of an elongated aluminum foil, was dried, and was thereafter pressed, to produce a positive electrode sheet A with the high Na content.

Further, this positive electrode sheet A was washed for 30 minutes using a mixed solvent that contained ethylene carbonate (EC), dimethyl carbonate (DMC) and ethyl methyl carbonate (EMC) at a volume ratio of EC:DMC:EMC=3:3:4, to prepare a positive electrode sheet B with the low Na content.

Part of the positive electrode active material layer of the obtained positive electrode sheet was cut out. Laser ablation ICP mass spectrometry was performed on this cutout as a sample, using a laser ICP mass spectrometer, to measure the Na content in the positive electrode active material layer. The results showed that the Na content in the positive electrode active material layer in the positive electrode sheet A was 183 μg/g, and the Na content in the positive electrode active material layer in the positive electrode sheet B was 88 μg/g.

Preparation of Separators

Two types of separator sheets having different Na contents were prepared. Specifically, a porous polyolefin sheet having a three-layer structure of PP/PE/PP and provided with an HRL was prepared as a separator sheet A with the high Na content. Further, the separator sheet A was washed with a mixed solvent containing EC, DMC and EMC at a volume ratio of EC:DMC:EMC=3:3:4 for 30 minutes, to prepare a separator sheet B with the low Na content.

Part of each prepared separator sheet was cut out. Laser ablation ICP mass spectrometry was performed on each cutout as a sample, using a laser ICP mass spectrometer, to measure the Na content in the respective separator sheet. The results showed that the Na content in the separator sheet A was 202 μg/g, and the Na content in the separator sheet B was 65 μg/g.

Production of Lithium Ion Secondary Batteries for Evaluation

Each positive electrode sheet, negative electrode sheet produced above, and two of each type of separator sheets prepared above were laid up on each other, and the resulting stack was wound, followed by squashing through pressing from the side-surface direction, to thereby produce a flat-shaped wound electrode body. Table 1 shows the Na content of each member that was used.

Next, a positive electrode terminal and a negative electrode terminal were connected to the wound electrode body, and the resultant was accommodated in a square battery case having an electrolyte solution injection port. Subsequently, a nonaqueous electrolyte solution was injected through the electrolyte solution injection port of the battery case, and the injection port was hermetically sealed. The nonaqueous electrolyte solution was prepared by dissolving LiPF₆ as a supporting salt, to a concentration of 1.1 mol/L, in a mixed solvent that contained ethylene carbonate (EC), dimethyl carbonate (DMC) and ethyl methyl carbonate (EMC), at a volume ratio of EC:DMC:EMC=3:3:4, and by further adding LiBOB to 0.5 mass %.

This was followed by an activation treatment, to yield lithium ion secondary batteries for evaluation of examples and comparative examples.

Amount of Na in Negative Electrode/Overall Amount of Na

A ratio of the Na content in the negative electrode active material layer relative to the total of Na content in the positive electrode active material layer, Na content in the negative electrode active material layer, and Na content in the separators, was calculated using the above results of laser ablation ICP mass spectrometry.

Resistance Distribution Measurement

Each prepared lithium ion secondary battery for evaluation was discharged down to an open circuit voltage of 3.0 V, and thereafter was disassembled in a glove box in a dry environment, and the wound electrode body was taken out. Next, the innermost circumference of the negative electrode of the wound electrode body was cut out to an appropriate size, and the cutout piece was washed through immersion in EMC for about 10 minutes, to prepare a specimen for resistance measurement. The reaction resistance on the surface of the negative electrode active material layer formed on the specimen was measured in accordance with the AC impedance method, along the width direction of the negative electrode active material layer. Resistance was measured in accordance with the AC impedance method disclosed in Japanese Patent Application Publication No. 2014-25850. Herein resistance values were determined at 5 mm-intervals over 30% of the negative electrode active material layer from the end portions thereof, and at 2 mm-intervals in the central portion (the remaining 40% portion).

Initial Resistance Ratio

Each lithium ion secondary battery for evaluation was adjusted to SOC 60%. The battery was placed in an environment of at −10° C., and was discharged for 10 seconds. The discharge current rates were set to 1 C, 3 C, 5 C and 10 C, and the voltage after discharge at each current rate was measured. Then, IV resistance was calculated from the current rate and the voltage, and the average value of IV resistance was taken as the battery resistance. Herein, the resistance of the lithium ion secondary battery of Comparative example 1 was taken as “100” and a ratio of the resistance of each of other batteries relative to that of Comparative example 1 in this case was determined. The results are shown in Table 1.

Resistance to Metallic Lithium Precipitation

Each lithium ion secondary battery for evaluation was placed in an environment at −10° C., was charged for 5 seconds at a predetermined current value, followed by a pause of 10 minutes, 5 seconds of discharge, and 10 minutes of pause. This charge and discharge cycle was then carried out over 1000 cycles. Thereafter, each lithium ion secondary battery was disassembled, and the occurrence or absence of precipitation of metallic lithium on the negative electrode was checked. The largest current value among the current values exhibiting no observable precipitation of metallic lithium on the negative electrode was taken as the limiting current value. The limiting current value of the lithium ion secondary battery of Comparative example 1 was taken as “100” and a ratio of the limiting current value of each of other batteries relative to that of Comparative example 1 in this case was determined. The results are shown in Table 1.

TABLE 1

| | Na content (μg/g) | | | | | | |
|---|---|---|---|---|---|---|---|
| | Negative electrode | Positive electrode | | Negative electrode | Site of highest | Limiting current | Initial |
| | active material | active material | | Na content/overall | resistance/site | ratio for Li | resistance |
| | layer | layer | Separator | Na content (%) | of lowest resistance | precipitation | ratio |
| Example 1 | 311 | 183 | 202 | 45 | 1.17 | 104 | 99 |
| Example 2 | 191 | 183 | 202 | 33 | 1.10 | 110 | 98 |
| Example 3 | 9 | 183 | 202 | 2 | 1.04 | 180 | 96 |
| Comp. | 420 | 183 | 202 | 52 | 1.29 | 100 | 100 |
| example 1 | | | | | | | |
| Comp. | 420 | 88 | 202 | 59 | 1.29 | 99 | 100 |
| example 2 | | | | | | | |
| Comp. | 420 | 183 | 65 | 63 | 1.3 | 101 | 100 |
| example 3 | | | | | | | |
| Comp. | 420 | 88 | 65 | 73 | 1.28 | 103 | 100 |
| example 4 | | | | | | | |

The results in Table 1 reveal that initial resistance was lower and resistance to metallic Li precipitation was higher in Embodiment 1 to 3, in which the Na content of the negative electrode active material layer was reduced, than in the comparative examples. It is found that a lower Na content in the negative electrode active material layer entails a lower initial resistance and a higher resistance to metallic Li precipitation. By contrast, a comparison of Comparative examples 1 to 4 reveals that neither initial resistance nor resistance to metallic Li precipitation is affected even when the Na content in the positive electrode active material layer is reduced. It is further found that initial resistance and resistance to metallic Li precipitation are not affected even when the Na content in the separators is reduced. It can also be seen that initial resistance is not affected, and virtually no effect of increasing the resistance to metallic Li precipitation is obtained, even when reducing both the Na content in the positive electrode active material layer and the Na content in the separators.

From the above, it is understood that the nonaqueous electrolyte secondary battery disclosed herein affords a low initial resistance and high resistance to metallic Li precipitation.

Concrete examples of the present disclosure have been explained in detail above, but the examples are merely illustrative in nature, and are not meant to limit the scope of the claims in any way. The art set forth in the claims encompasses various alterations and modifications of the concrete examples illustrated above.

What is claimed is:

1. A nonaqueous electrolyte secondary battery comprising:
an electrode body having a positive electrode, a negative electrode, and a separator; and
a nonaqueous electrolyte solution, wherein
the negative electrode has a negative electrode active material layer,
the nonaqueous electrolyte solution contains lithium bis(oxalato)borate, and
a Na content in the negative electrode active material layer, determined by laser ablation ICP mass spectrometry, is 311 μg/g or lower.

2. The nonaqueous electrolyte secondary battery according to claim 1, wherein
the positive electrode has a positive electrode active material layer, and
a ratio (%) of the Na content in the negative electrode active material layer relative to the total of Na content in the positive electrode active material layer, Na content in the negative electrode active material layer, and Na content in the separator, is 33% or lower.

3. The nonaqueous electrolyte secondary battery according to claim 1, wherein a ratio (%) of a resistance value at a site of highest resistance relative to a resistance value at a site of lowest resistance, upon measurement of a resistance distribution along a short-side direction of a main surface of the negative electrode active material layer, is 1.10 or lower.

4. The nonaqueous electrolyte secondary battery according to claim 1, wherein
the negative electrode active material layer contains a negative electrode active material, a binder and a thickener, and
the thickener is a salt of carboxymethyl cellulose, and at least part of cations of the carboxymethyl cellulose salt are Li ions.

5. The nonaqueous electrolyte secondary battery according to claim 1, wherein the negative electrode active material layer contains a negative electrode active material, and a Na-free acrylic binder.

6. The nonaqueous electrolyte secondary battery according to claim 1, wherein the electrode body is a wound electrode body.
